(19) United States
(12) Patent Application Publication
(10) Pub. No.: US 2025/0374195 A1
(43) Pub. Date: Dec. 4, 2025

(54) METHOD AND APPARATUS FOR NETWORK ENERGY SAVING

(71) Applicant: KT CORPORATION, Gyeonggi-do (KR)

(72) Inventor: Chungwoo HWANG, Gyeonggi-do (KR)

(73) Assignee: KT CORPORATION, Gyeonggi-do (KR)

(21) Appl. No.: 19/304,895

(22) Filed: Aug. 20, 2025

Related U.S. Application Data
(63) Continuation of application No. PCT/KR2024/002175, filed on Feb. 20, 2024.

(30) Foreign Application Priority Data
Feb. 20, 2023 (KR) 10-2023-0022472
Feb. 19, 2024 (KR) 10-2024-0023813

(51) Int. Cl. H04W 52/02; H04B 17/318; H04W 76/28

(52) U.S. Cl. CPC H04W 52/0235; H04B 17/328; H04W 76/28

(57) ABSTRACT

Provided are a method and apparatus for network energy saving in a wireless communication system. A terminal or communication device identifies a base station. Then, the terminal or communication device determines whether the identified base station operates in a base station energy saving mode. Thereafter, the terminal or communication device transmits a deactivation request of the base station energy saving mode to the base station and transmits and receives data with the base station while the base station energy saving mode has been deactivated. Here, the base station energy saving mode is based on cell discontinuous transmission (DTX) and/or cell discontinuous reception (DRX). If the base station energy saving mode is based on another energy saving scheme such as power/space/frequency-domain techniques, a different neighboring base station is identified.

### TECHNICAL FIELD

The present disclosure relates to a 3GPP 5G NR system.

### BACKGROUND ART

As more communication devices require greater communication traffic, necessity for a next generation 5G system, which is enhanced compared to a legacy LTE system, is emerging. In the next generation 5G system, scenarios can be classified into Enhanced Mobile BroadBand (eMBB), Ultra-reliability and low-latency communication (URLLC), Massive Machine-Type Communications (mMTC), and the like.

Here, eMBB corresponds to a next generation mobile communication scenario having characteristics such as high spectrum efficiency, high user experienced data rate, high peak data rate, and the like. URLLC corresponds to a next generation mobile communication scenario having characteristics such as ultra-reliable, ultra-low latency, ultra-high availability, and the like (e.g., V2X, Emergency Service, Remote Control). mMTC corresponds to a next generation mobile communication scenario having characteristics such as low cost, low energy, short packet, and massive connectivity (e.g., IoT).

### DISCLOSURE OF INVENTION

### Technical Problem

The disclosure is to provide a method and apparatus for applying an efficient network energy saving (NES) mode in a wireless communication system.

### Solution to Problem

In accordance with an embodiment, a method of a terminal in a wireless communication system may be provided for identifying a base station. The method may include identifying whether the identified base station is operating in a base station energy saving mode, transmitting a release request (e.g., deactivation request) of a base station energy saving mode to the base station, and transmitting and receiving data with the base station after the base station energy saving mode is deactivated. Here, the base station energy saving mode is based on cell discontinuous transmission (DTX) and/or cell discontinuous reception (DRX).

In accordance with another embodiment, a communication apparatus in a wireless communication system may be provided. The apparatus may include: at least one processor; and at least one memory configured to store instructions and operably electrically connectable to the at least one processor. Operations performed based on the instructions executed by the at least one processor may include: identifying a base station, identifying whether the identified base station is operating in a base station energy saving mode, transmitting a release request (e.g., deactivation request) of a base station energy saving mode to the base station, and transmitting and receiving data with the base station after the base station energy saving mode is released. Here, the base station energy saving mode is based on cell discontinuous transmission (DTX) and/or cell discontinuous reception (DRX).

The transmission of the release request of the base station energy saving mode is performed when the terminal is configured with connected mode DRX (C-DRX).

The release request of the base station energy saving mode may be transmitted through radio resource control (RRC) signaling.

The identification of the base station may be based on a reference signal received power (RSRP) of the base station, and the RSRP is lower than a reference value.

In accordance with further another embodiment, a method of a first base station in a wireless communication system may be provided for identifying a non-reception of a random access preamble from a terminal, acquiring a reference signal received power (RSRP) of a second base station after identifying the non-reception of the random access preamble, and performing a base station energy saving mode when the acquired RSRP of the second base station is greater than or equal to a configured value.

In accordance with yet another embodiment, a base station in a wireless communication system may be provided. The base station may include: at least one processor; and at least one memory configured to store instructions and operably electrically connectable to the at least one processor. Operations performed based on the instructions executed by the at least one processor may include: identifying a non-reception of a random access preamble from a terminal, acquiring a reference signal received power (RSRP) of a neighboring base station after identifying the non-reception of the random access preamble, and performing a base station energy saving mode when the acquired RSRP of the neighboring base station is greater than or equal to a configured value.

The first base station (or base station) may acquire a cell identity of a second base station (or neighboring base station), and the acquisition of the RSRP of the second base station (or neighboring base station) may be based on the cell identity.

Meanwhile, the base station energy saving mode may be based on cell discontinuous transmission (DTX) and/or cell discontinuous reception (DRX).

### Advantageous Effects of Invention

According to the embodiments of the disclosure, an efficient network energy saving (NES) mode can be applied in a wireless communication system.

### BRIEF DESCRIPTION OF DRAWINGS

FIG. 1 illustrates a wireless communication system.

FIG. 2 illustrates a structure of a radio frame used in NR.

FIGS. 3A to 3C illustrate exemplary architectures for a wireless communication service.

FIG. 4 illustrates a slot structure of a new radio (NR) frame.

FIG. 5 shows an example of a subframe type in NR.

FIG. 6 illustrates a structure of a self-contained slot.

FIG. 7 is a diagram illustrating an example of a DRX cycle.

FIG. 8 is a diagram illustrating an example of operations of a cell DTX/DRX and a terminal DRX according to an embodiment of the disclosure.

FIG. 9 is a diagram illustrating an example scenario that may occur when a base station energy saving mode is applied.

FIG. 10 is a flowchart illustrating a procedure related to the energy saving mode according to an embodiment.

FIG. 11 is a flowchart illustrating a procedure related to the energy saving mode according to another embodiment.

FIG. 12 shows apparatuses according to an embodiment of the disclosure.

FIG. 13 is a block diagram showing a configuration of a terminal according to an embodiment of the disclosure.

FIG. 14 is a configuration block diagram of a processor in which the disclosure is implemented.

FIG. 15 is a detailed block diagram of a transceiver of a first apparatus shown in FIG. 12 or a transceiving unit of an apparatus shown in FIG. 13.

### Mode for the Invention

The technical terms used herein are intended to merely describe specific embodiments and should not be construed as limiting the disclosure. Further, unless otherwise defined, the technical terms used herein should be interpreted as having meanings generally understood by those skilled in the art but not too broadly or too narrowly. Additionally, technical terms that do not precisely reflect the spirit of the disclosure should be replaced with, or understood as, technical terms that can be accurately understood by those skilled in the art. Finally, the general terms used herein should be interpreted in the context as defined in the dictionary, but not in an excessively narrowed manner.

The expression of the singular form in the disclosure includes the meaning of the plural form unless the context explicitly requires otherwise. In the following description, the term ‘include’ or ‘have’ may represent the existence of a feature, a number, a step, an operation, a component, a part or the combination thereof described in the disclosure and may not exclude the existence or addition of any other feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without departing from the scope of the disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the disclosure will be described in greater detail with reference to the accompanying drawings. For clarity, the same reference numerals are used to denote the same components throughout the drawings, and repetitive description on the same components will be omitted. Descriptions of well- known techniques that may make the disclosure unclear will also be omitted. The accompanying drawings are provided merely to illustrate the spirit of the disclosure and should not be constructed as limiting. It should be understood that the spirit of the disclosure includes modifications, replacements or equivalents in addition to what is shown in the drawings.

In the disclosure, “A or B” may mean “only A”, “only B”, or “both A and B”. In other words, “A or B” in the disclosure may be interpreted as “A and/or B”. For example, “A, B or C” in the disclosure may mean “only A”, “only B”, “only C”, or “any combination of A, B and C”.

In the disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the disclosure, “at least one of A and B” may mean “only A”, “only B” or “both A and B”. In addition, the expression “at least one of A or B” or “at least one of A and/or B” in the disclosure may be interpreted as the same as “at least one of A and B”.

In addition, in the disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the disclosure may indicate “for example”. For example, when presented as “control information (PDCCH)”, the “physical downlink control channel (PDCCH)” may be provided as an example of “control information”. In other words, “control information” in the disclosure is not limited to “PDCCH”, and “PDDCH” is merely an example of “control information”. Similarly, even when shown as “control information (i.e., PDCCH)”, “PDCCH” may be provided as an example of “control information”.

The technical features described individually in one drawing in this specification may be implemented separately or at the same time.

In the accompanying drawings, user equipment (UE) is illustrated by way of example, but the illustrated UE may be also referred to as a terminal, mobile equipment (ME), or the like. In addition, the UE may be a portable device such as a laptop computer, a mobile phone, a PDA, a smart phone, a multimedia device, or the like, or may be a non-portable device such as a PC or a vehicle-mounted device.

Hereinafter, the UE is used as an example of a device capable of wireless communication (e.g., a wireless communication device, a wireless device, or a wireless apparatus). The operation performed by the UE may be performed by any device capable of wireless communication. A device capable of wireless communication may also be referred to as a radio communication device, a wireless device, or a wireless apparatus.

A base station, a term used below, generally refers to a fixed station that communicates with a wireless device, and may be used to cover the meanings of terms including an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), a repeater (relay), and so on.

Although embodiments of the disclosure will be described based on an LTE system, an LTE-advanced (LTE-A) system, and an NR system, such embodiments may be applied to any communication system falling within the above definitions.

### Wireless Communication System

With the success of long term evolution (LTE)/LTE-A (LTE-Advanced) for the 4th generation mobile communication, the next generation, i.e., 5^{th} generation (so called 5G) mobile communication has been commercialized and subsequent studies are ongoing.

The 5^{th} generation mobile communications defined by the International Telecommunication Union (ITU) refers to a system that provides a data transmission rate of up to 20 Gbps and a minimum actual transmission rate of at least 100 Mbps anywhere. The official name of the 5^{th} generation mobile telecommunications is ‘IMT-2020.’

The ITU proposes three usage scenarios, namely, enhanced Mobile Broadband (eMBB), massive Machine Type Communication (mMTC) and Ultra Reliable and Low Latency Communications (URLLC).

The URLLC relates to a usage scenario that requires high reliability and low latency. For example, services such as autonomous driving, factory automation, augmented reality require high reliability and low latency (e.g., a delay time of less than 1 ms). The latency for current 4G (LTE) is statistically 21 to 43 ms (best 10%) and 33 to 75 ms (median). This is insufficient to support a service requiring latency below 1 ms. Next, the eMBB usage scenario relates to a usage scenario requiring mobile ultra-wideband.

That is, the 5G mobile communication system supports higher capacity than the current 4G LTE, and may increase the density of mobile broadband users and support device to device (D2D), high stability, and machine type communication (MTC). The 5G research and development also aims at a lower latency time and reduce battery consumption compared to a 4G mobile communication system to better implement the Internet of things. A new radio access technology (new RAT or NR) may be proposed for such 5G mobile communication.

An NR frequency band is defined as two types of frequency ranges: FR1 and FR2. The numerical value in each frequency range may vary, and the frequency ranges of the two types FR1 and FR2 may for example be shown in Table 1 below. For convenience of description, FR1 among the frequency ranges used in the NR system may refer to a Sub-6 GHz range, and FR2 may refer to an above-6 GHz range, which may be called millimeter waves (mmWs).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values in the frequency range may vary in the NR system. For example, FR1 may range from 410 MHz to 7125 MHz as listed in [Table 1]. That is, FR1 may include a frequency band of 6 GHz (or 5850, 5900, and 5925 MHz) or above. For example, the frequency band of 6 GHz (or 5850, 5900, and 5925 MHz) or above may include an unlicensed band. The unlicensed band may be used for various purposes, such as, vehicle communication (e.g., autonomous driving).

Meanwhile, the 3GPP communication standards define downlink (DL) physical channels corresponding to resource elements (REs) carrying information originating from a higher layer, and DL physical signals which are used in the physical layer and correspond to REs that do not carry information originated from a higher layer. For example, physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as DL physical channels, and reference signals (RSs) and synchronization signals (SSs) are defined as DL physical signals. An reference signal (RS), also called a pilot signal, is a signal with a predefined special waveform known to both a gNode B (gNB) and a UE. For example, cell specific RS, UE-specific RS (UE-RS), positioning RS (PRS), and channel state information RS (CSI-RS) are defined as DL RSs. The 3GPP LTE/LTE-A standards define uplink (UL) physical channels corresponding to REs carrying information originated from a higher layer, and UL physical signals which are used in the physical layer and correspond to REs which do not carry information originated from a higher layer. For example, physical uplink shared channel (PUSCH), physical uplink control channel (PUCCH), and physical random access channel (PRACH) are defined as UL physical channels, and a demodulation reference signal (DMRS) for a UL control/data signal, and a sounding reference signal (SRS) used for UL channel measurement are defined as UL physical signals.

In the disclosure, the PDCCH/PCFICH/PHICH/PDSCH refers to a set of time-frequency resources or a set of REs, which carry downlink control information (DCI)/a control format indicator (CFI)/a DL acknowledgement/negative acknowledgement (ACK/NACK)/DL data. Further, the PUCCH/PUSCH/PRACH refers to a set of time-frequency resources or a set of REs, which carry UL control information (UCI)/UL data/a random access signal.

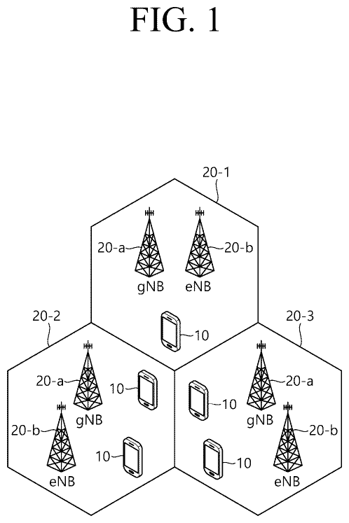

FIG. 1 illustrates a wireless communication system.

Referring to FIG. 1, the wireless communication system includes at least one base station (BS). The BS includes a gNodeB (or gNB) 20a and an eNodeB (or eNB) 20b. The gNB 20a supports the 5G mobile communication. The eNB 20b supports the 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (serving BS). Since the wireless communication system is a cellular system, other cells adjacent to the serving cell exist. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, the transmitter may be a part of the base station 20, and the receiver may be a part of the UE 10. In the uplink, the transmitter may be a part of the UE 10, and the receiver may be a part of the base station 20.

Meanwhile, a wireless communication system may be largely divided into a frequency division duplex (FDD) scheme and a time division duplex (TDD) scheme. According to the FDD scheme, uplink transmission and downlink transmission are performed while occupying different frequency bands. According to the TDD scheme, uplink transmission and downlink transmission are performed at different times while occupying the same frequency band. The channel response of the TDD scheme is substantially reciprocal. This means that the downlink channel response and the uplink channel response are almost the same in a given frequency domain. Accordingly, in the TDD-based radio communication system, there is an advantage that the downlink channel response can be obtained from the uplink channel response. In the TDD scheme, since uplink transmission and downlink transmission are time-divided in the entire frequency band, downlink transmission by the base station and uplink transmission by the UE cannot be performed simultaneously. In a TDD system in which uplink transmission and downlink transmission are divided in subframe units, uplink transmission and downlink transmission are performed in different subframes.

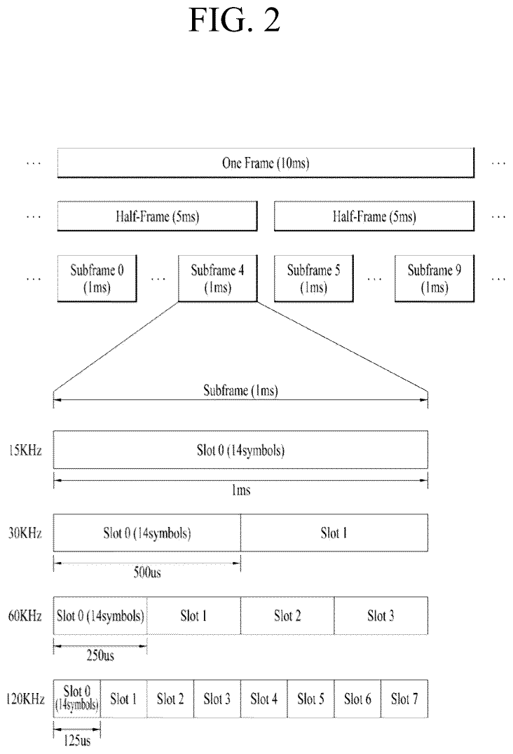

FIG. 2 illustrates a structure of a radio frame used in NR.

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on an SCS. Each slot includes 12 or 14 OFDM(A) symbols according to a CP. When a normal CP is used, each slot includes 14 OFDM symbols. When an extended CP is used, each slot includes 12 OFDM symbols. A symbol may include an OFDM symbol (CP-OFDM symbol) and an SC-FDMA symbol (or DFT-s-OFDM symbol).

### Support of Various Numerologies

With the development of wireless communication technology, multiple numerologies may be available to UEs in the NR system. For example, in the case where a subcarrier spacing (SCS) is 15 kHz, a wide area of the typical cellular bands is supported. In the case where an SCS is 30 kHz/60 kHz, a dense-urban, lower latency, wider carrier bandwidth is supported. In the case where the SCS is 60 kHz or higher, a bandwidth that is greater than 24.25 GHz is supported in order to overcome phase noise.

The numerologies may be defined by a cyclic prefix (CP) length and a subcarrier spacing (SCS). A single cell can provide a plurality of numerologies to UEs. When an index of a numerology is represented by μ, a subcarrier spacing and a corresponding CP length may be expressed as shown in the following table.

TABLE 2

| μ | Δf = 2^{μ} · 15 [kHz] | CP |
|---|---|---|
| 0 | 15 | normal |
| 1 | 30 | normal |
| 2 | 60 | normal, |
| | | extended |
| 3 | 120 | normal |
| 4 | 240 | normal |
| 5 | 480 | normal |
| 6 | 960 | normal |

In the case of a normal CP, when an index of a numerology is expressed by μ, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 3

| μ | Δf = 2^{μ} · 15 [kHz] | N^{slot}_{symb} | N^{frame, μ}ₛₗₒₜ | N^{subframe, μ}ₛₗₒₜ |
|---|---|---|---|---|
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

In the case of an extended CP, when an index of a numerology is represented by μ, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 4

| μ | SCS (15*2u) | N^{slot}_{symb} | N^{frame, μ}ₛₗₒₜ | N^{subframe, μ}ₛₗₒₜ |
|---|---|---|---|---|
| 2 | 60 KHz | 12 | 40 | 4 |
| | (u = 2) | | | |

In the NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

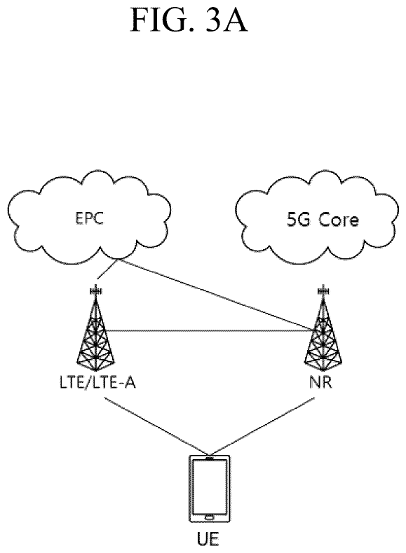

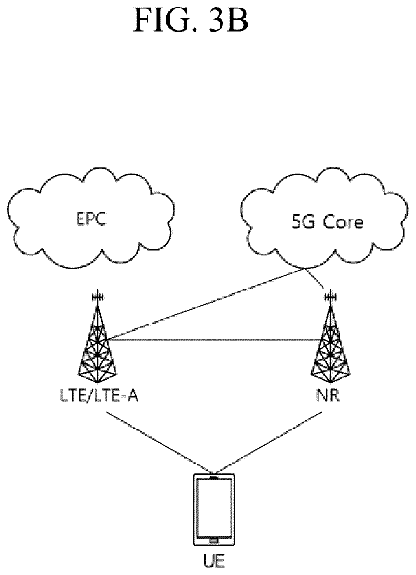

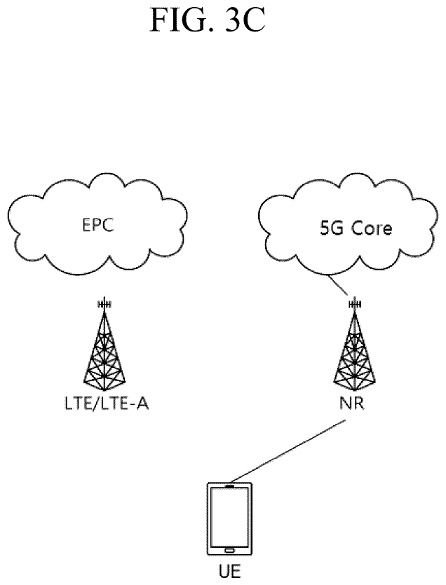

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, an Evolved Packet core (EPC).

Referring to FIG. 3B, the LTE/LTE-A cell is connected with a core network for 5th generation mobile communication, that is, a 5G core network, unlike the example in FIG. 3A.

A service based on the architecture shown in FIGS. 3A and 3B is referred to as a non-standalone (NSA) service.

Referring to FIG. 3C, a UE is connected only with an NR cell. A service based on this architecture is referred to as a standalone (SA) service.

Meanwhile, in the forementioned new radio access technology (NR), using a downlink subframe for reception from a base station and using an uplink subframe for transmission to the base station may be considered. This method may be applied to both paired and unpaired spectrums. A pair of spectrums refers to two subcarriers for downlink and uplink operations. For example, one subcarrier in one pair of spectrums may include a pair of a downlink band and an uplink band.

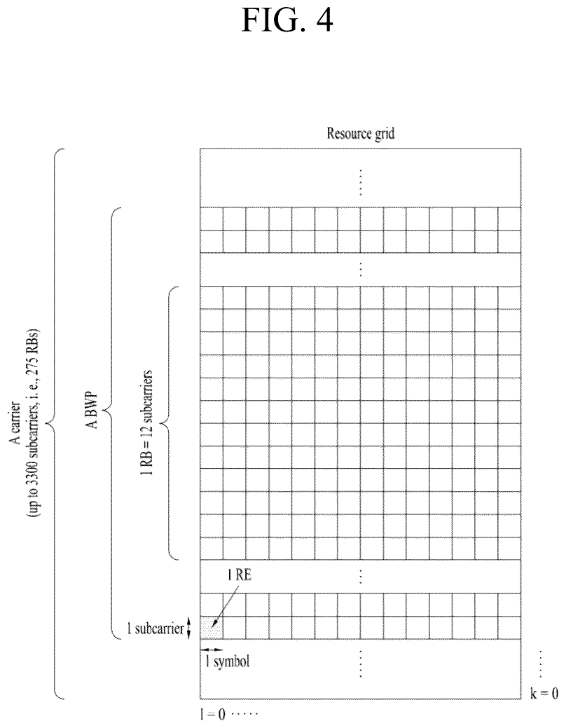

FIG. 4 illustrates a slot structure of an NR frame.

A slot includes a plurality of symbols in the time domain. For example, in the case of the normal CP, one slot includes seven symbols. On the other hand, in the case of an extended CP, one slot includes six symbols. A carrier includes a plurality of subcarriers in the frequency domain. A resource block (RB) is defined as consecutive subcarriers (e.g., 12 consecutive subcarriers) in the frequency domain. A bandwidth part (BWP) is defined as a plurality of consecutive physical resource blocks (PRBs) in the frequency domain and may correspond to one numerology (e.g., SCS, CP length, etc.). A UE may be configured with up to N (e.g., five) BWPs in both the downlink and the uplink. The downlink or uplink transmission is performed through an activated BWP, and only one BWP among the BWPs configured for the UE may be activated at a given time. In the resource grid, each element is referred to as a resource element (RE), and one complex symbol may be mapped thereto.

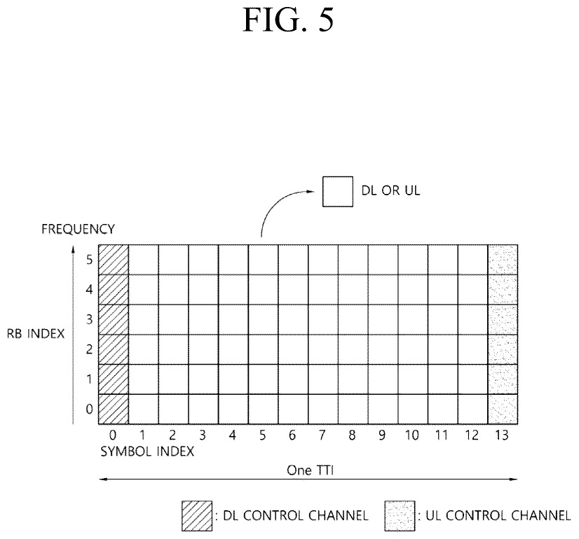

FIG. 5 shows an example of a subframe type in NR.

Referring to FIG. 5, a TTI (Transmission Time Interval) may be called a subframe or a slot for NR (or new RAT). The subframe (or slot) shown in FIG. 5 can be used in a TDD system of NR (or new RAT) to minimize data transmission delay. As shown in FIG. 5, a subframe (or slot) includes 14 symbols. The symbol at the head of the subframe (or slot) can be used for a DL control channel and the symbol at the end of the subframe (or slot) can be used for a UL control channel. The remaining symbols can be used for DL data transmission or UL data transmission. According to this subframe (or slot) structure, downlink transmission and uplink transmission can be sequentially performed in one subframe (or slot). Accordingly, downlink data can be received in a subframe (or slot) and uplink ACK/NACL may be transmitted in the subframe (or slot).

Such a subframe (or slot) structure may be called a self-contained subframe (or slot).

Specifically, the first N symbols (hereinafter referred to as the DL control region) in a slot may be used to transmit a DL control channel, and the last M symbols (hereinafter referred to as the UL control region) in the slot may be used to transmit a UL control channel. N and M are integers greater than 0. A resource region between the DL control region and the UL control region (hereinafter referred to as a data region) may be used for DL data transmission or UL data transmission. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

When this subframe (or slot) structure is used, a time taken to retransmit data that has failed in reception may be reduced to minimize final data transmission latency. In such a self-contained subframe (or slot) structure, a time gap may be required in a process of transition from a transmission mode to a reception mode or from the reception mode to the transmission mode. To this end, some OFDM symbols when DL switches to UL in the subframe structure can be configured to a guard period (GP).

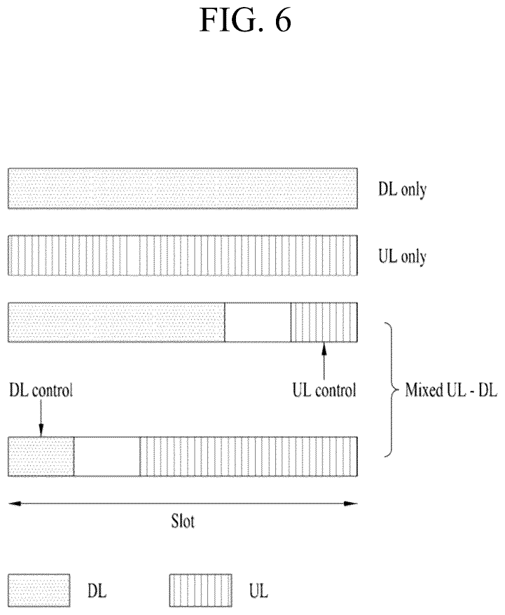

FIG. 6 illustrates a structure of a self-contained slot.

In the NR system, the frame has a self-contained structure, in which all of a DL control channel, DL or UL data channel, UL control channel, and other elements are included in one slot. For example, the first N symbols (hereinafter referred to as a DL control region) in a slot may be used for transmitting a DL control channel, and the last M symbols (hereinafter referred to as an UL control region) in the slot may be used for transmitting an UL control channel. N and M are integers greater than 0. A resource region between the DL control region and the UL control region (hereinafter referred to as a data region) may be used for DL data transmission or UL data transmission. For example, the following configurations may be taken into account. The durations are listed in temporal order.
1. DL only configuration
2. UL only configuration
3. Mixed UL-DL configuration

$$DL region + Guard Period ( GP ) + UL control region$$

$$DL control region + GP + UL region$$

DL region: (i) DL data region, (ii) DL control region+DL data region
UL region: (i) UL data region, (ii) UL data region+UL control region

A PDCCH may be transmitted in the DL control region, and a PDSCH may be transmitted in the DL data region. A PUCCH may be transmitted in the UL control region, and a PUSCH may be transmitted in the UL data region. In the PDCCH, Downlink Control Information (DCI), for example, DL data scheduling information or UL data scheduling data may be transmitted. In the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A GP provides a time gap during a process where a gNB and a UE transition from the transmission mode to the reception mode or a process where the gNB and UE transition from the reception mode to the transmission mode. Part of symbols belonging to the occasion in which the mode is changed from DL to UL within a subframe may be configured as the GP.

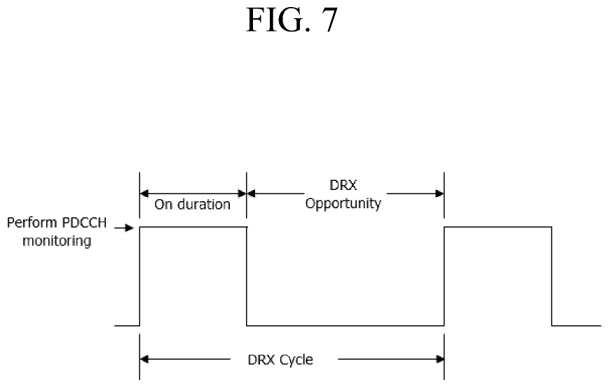

FIG. 7 illustrates an example of a DRX cycle.

Referring to FIG. 7, a UE uses DRX to save power. When DRX is configured, the UE is not required to continuously perform PDCCH monitoring. In other words, the UE attempts to receive the PDCCH only within the configured time interval and does not attempt to receive the PDCCH outside the configured time interval. The duration during which the UE performs the PDCCH monitoring is referred to as an ‘On Duration,’ and the On Duration is defined once per DRX period.

The DRX operation includes the following features.
On Duration: Duration during which the UE waits to receive the PDCCH after waking up. If the UE successfully decodes the PDCCH, the UE stays awake and starts an Inactivity Timer.
Inactivity Timer: A timer indicating a duration following the last successful PDCCH decoding, during which the UE monitors for subsequent PDCCHs and transitions to sleep upon a decoding failure. The UE restarts the Inactivity Timer after successfully decoding the PDCCH only for the first transmission (i.e., not for retransmission).
Retransmission Timer: A timer indicating a duration until an expected retransmission occurs.
Cycle: indicates a periodic repetition of the On duration and a subsequent possible inactivity period.
Active Time: The overall duration in which the UE monitors the PDCCH, including the On Duration of the DRX cycle, the period during which the UE continues reception while the Inactivity Timer is running, and the period while waiting for a retransmission occasion.

Meanwhile, the ITU-R IMT-2020 Vision document (ITU-R M.2083) defines energy efficiency as a key performance indicator (KPI) for 5G. To meet this, 3GPP has standardized power saving technologies for user equipment, and in 5G-Advanced, various technologies to improve base station energy efficiency have been studied. According to the 3GPP TR 38.864 technical report, to enhance network energy efficiency from the base station perspective, energy saving technologies in the time domain, frequency domain, spatial domain, and power domain have been studied, along with methods for energy efficiency improvement through higher layer optimization. Some of the various energy saving technologies mentioned in the 3GPP TR 38.864 technical report are expected to be standardized in Release 18, and technologies not completed in Release 18 are anticipated to be finalized in subsequent releases (Release 19 and beyond).

Traditionally, unlike user equipment (UE) that uses limited power sources such as batteries due to its form factor in wireless access networks, base station equipment has been designed with the goal of maximizing performance since it is not constrained by power limitations. As networks evolve to support diverse services, transmission and reception speeds have increased, and the use of multiple antennas to support wider bandwidths has become widespread, resulting in significantly higher energy consumption at base stations. According to a study by GSMA (see, refer to “GSMA Future Networks: Energy Efficiency: An Overview”), the power consumption of base stations accounts for approximately 20-40% of the total network operating costs, with a particularly significant proportion in the wireless access network. To address this, various technologies aimed at improving base station energy efficiency are expected to emerge.

Power consumption at a base station may be categorized into two types. The first is dynamic power consumption, which occurs only during actual data transmission and reception take place. The second is static power consumption, which occurs regardless of data transmission or reception to perform essential network operation functions. To improve network energy efficiency at the base station, both the dynamic and static power consumption must be considered, and various network energy saving technologies should be applied dynamically or semi-statically to minimize base station performance degradation while maximizing energy efficiency.

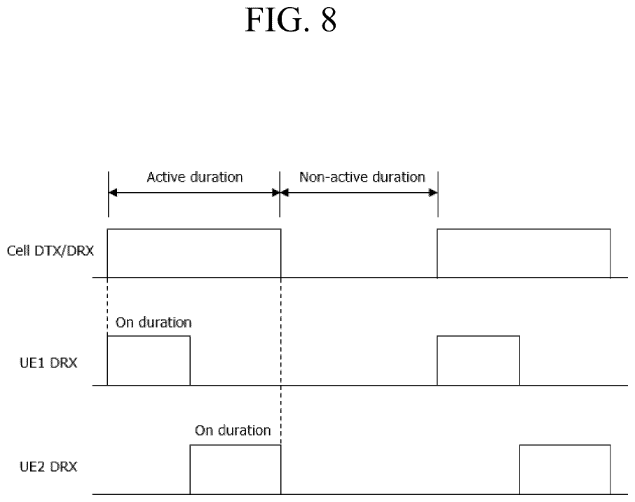

FIG. 8 is a diagram illustrating an example of operations of a cell DTX/DRX and a terminal DRX (e.g., UE DRX) according to an embodiment of the disclosure.

As an example of an energy saving technology in the time domain to improve network energy efficiency from the base station perspective, cell DTX/DRX may be applied.

Referring to FIG. 8, the cell DTX/DRX may be configured for the cell associated with the base station. The cell DTX/DRX may be classified according to an active duration and an inactive duration, and the base station and the UE may perform transmission and reception of data and/or a signal in the active duration of the cell DTX/DRX and may not perform transmission and reception of data and/or signals in the inactive duration of the cell DTX/DRX.

Meanwhile, the UE DRX may be defined and performed within the active duration of the cell DTX/DRX. In other words, PDCCH monitoring based on the UE DRX may be performed during the On Duration within the active duration of the cell DTX/DRX. The On Duration of the UE DRX (UE1 DRX and UE2 DRX) may be configured to either overlap or be non-overlapping within the active duration of the cell DTX/DRX.

FIG. 8 illustrates that the start or end of the On Duration of each UE DRX coincides with the start or end of the active duration of the cell DTX/DRX. However, this is merely an example, and the start or end of the On Duration of the UE DRX may be non-coincident with the start or end of the active duration of the cell DTX/DRX. In other words, the On Duration of the UE DRX may be configured to occupy any portion within the active duration of the cell DTX/DRX. Alternatively, the start or end of the On Duration of the UE DRX may be configured to be offset relative to the start or end of the active duration of the cell DTX/DRX.

Further, although not shown in FIG. 8, the cell DTX and the cell DRX may be configured independently of each other. In other words, the cell DTX and the cell DRX may be configured to have their own active and inactive durations, respectively.

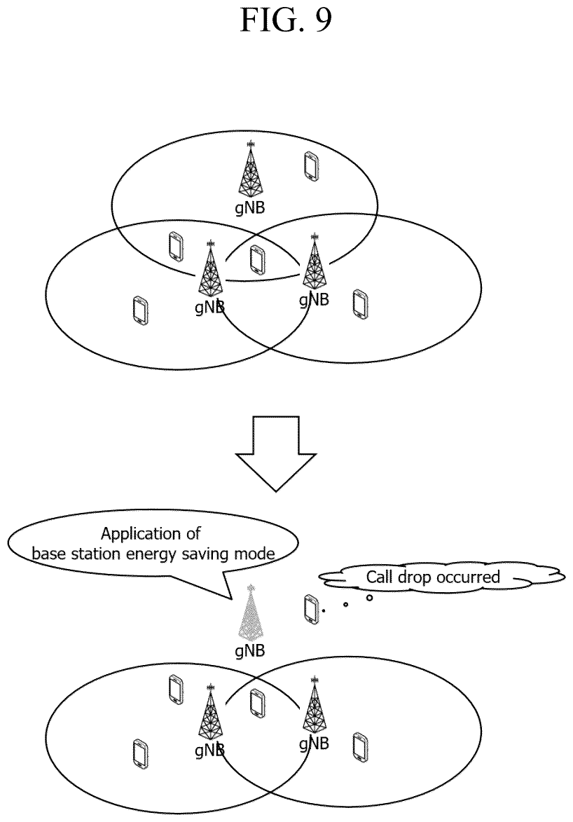

FIG. 9 is a diagram illustrating an example scenario that may occur when a base station energy saving mode is applied

As described above, the performance of a base station and network energy efficiency are in a conflicting relationship. Therefore, while maximizing network energy efficiency at the base station, performance degradation such as reduced transmission and reception speed or coverage shrinkage may occur.

Referring to FIG. 9, when a specific base station (gNB) applies an energy saving mode, its coverage may be reduced, which can cause call drops for terminals within that coverage.

The present specification describes the application of energy saving technology and a method and apparatus for controlling the same that increases energy efficiency through the application of base station energy saving techniques while preventing call drops caused by coverage reduction thereof.

Before entering the energy (power) saving mode at the base station, an option may be provided to apply the base station energy saving mode 1) dynamically, 2) semi-statically, or 3) statically, by confirming whether to use the function and providing surrounding environment information for such confirmation.

A base station may measure various information from neighboring cells, where the measurable information includes the following:
1) RSRP (Reference Signal Received Power): Refers to the received power of a reference signal (RS), which indicates the signal strength of a neighboring base station is determined.
2) RSRQ (Reference Signal Received Quality): Refers to the quality of the reference signal, considering both signal strength and interference levels from neighboring base stations.
3) CI (Cell Identity): A unique ID assigned to each neighboring base station.
4) ARFCN (Absolute Radio Frequency Channel Number): A unique carrier frequency assigned for acquiring information about neighboring cells.
5) TDOA (Time Difference of Arrival): Allows comparison of signal arrival times to identify the location of neighboring base stations.
6) AOA (Angle of Arrival): Determines the reception angle of a signal to determine the direction of a neighboring base station relative to the receiver.
7) RSTD (Reference Signal Time Difference): Calculates the time difference of reference signals received from neighboring base stations to identify the time offset between the neighboring base stations.

Based on the neighboring base station signal information measurable by the base station, the base station may determine whether it can enter the energy saving mode and execute the energy saving mode according to the configuration.

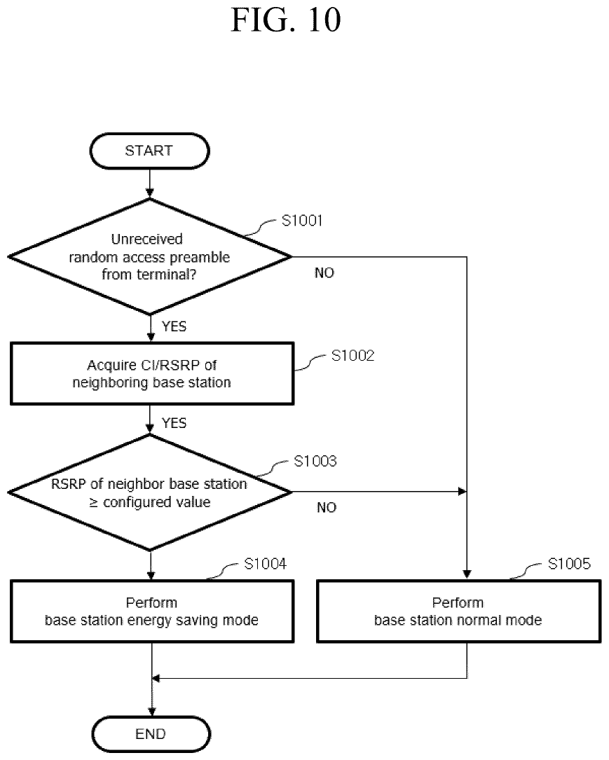

FIG. 10 is a flowchart illustrating a procedure related to the energy saving mode according to an embodiment.

Referring to FIG. 10, to determine whether to perform the energy saving mode or the normal mode, the base station first identifies whether a random access preamble is received from a terminal. In other words, the base station identifies whether the random access preamble from the terminal is not received (S1001). Here, the reception or non-reception of the random access preamble may be identified over a predetermined time interval. That is, if no random access preamble is received during the predetermined time interval, it may be determined to be not received.

When non-receipt of a random access preamble from a terminal is identified, the base station (first base station) may acquire a cell identity (CI) and/or reference signal received power (RSRP) of a neighboring base station (second base station) (S1002). The neighboring base station may be identified through its cell identity (CI), and by measuring or receiving signals from the neighboring base station, the RSRP information (e.g., RSRP value) of the neighboring base station may be acquired.

The acquired RSRP of the neighboring base station is compared with a configured value (for example, −90 dBm) (S1003), and if the RSRP is equal to or greater than the configured value, the base station may switch to the energy saving mode (S1004). In other words, the base station can minimize power consumption by applying the energy saving mode. If the acquired RSRP of the neighboring base station is lower than the configured value, the base station may maintain operation in the normal mode without applying energy saving (S1005).

As described above, the base station energy saving mode may be controlled dynamically, however, when there are concerns about coverage reduction, the base station may perform the energy saving mode semi-statically. That is, the energy saving mode may be configured to operate only during off-peak hours (for example, from 1 a.m. to 5 a.m.), and during the off-peak hours, the energy saving mode may be activated only when there are no terminal connection attempts and the RSRP measured or received from neighboring base stations based on their cell identity (CI) is equal to or greater than a configured value. In this case, although the power consumption improvement effect is less than when the base station performs the energy saving mode dynamically, concerns about coverage reduction outside the off-peak hours can be alleviated.

In office areas with few terminal connections on weekends or during off-peak hours, the base station may operate in the energy saving mode statically to minimize power consumption.

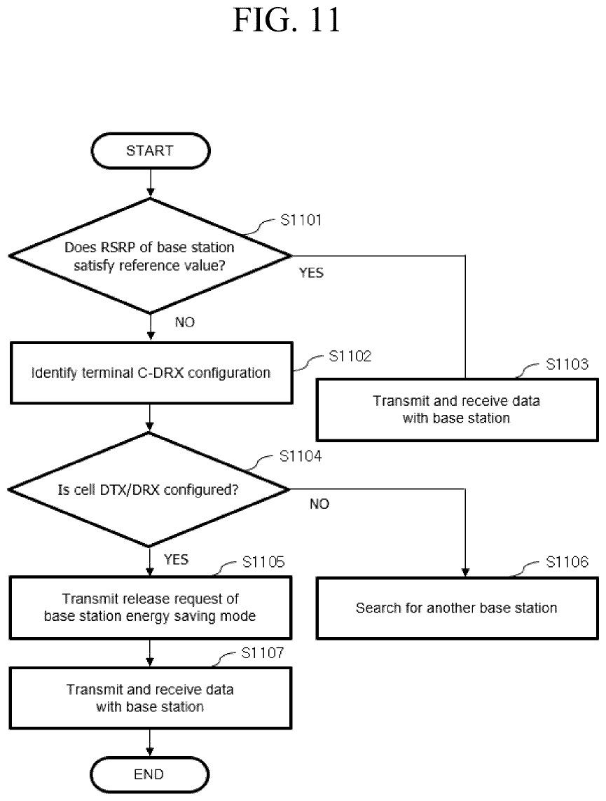

FIG. 11 is a flowchart illustrating a procedure related to the energy saving mode according to another embodiment.

When a terminal enters a base station operating in an energy saving mode, it may identify whether there is a nearby accessible base station. In this case, the terminal may perform a random access procedure.

Through the process of identifying whether there is an accessible base station, the terminal determines whether the RSRP of a specific base station meets a reference value (S1101). When the RSRP of the specific base station meets the reference value, the terminal attempts to connect to the base station, establishes a connection, and then transmits and receives data (S1103).

If a base station is operating in an energy saving mode, legacy terminals may not be able to detect the presence of that base station. However, if the base station is performing a time domain energy saving mode based on cell discontinuous transmission (DTX) and/or cell discontinuous reception (DRX), terminals supporting Release 18 or later can deactivate the base station energy saving (network energy savings, NES) mode via RRC signaling while in the RRC_CONNECTED state. In this case, the terminal may identify the base station through the process of identifying whether there is an accessible base station. This corresponds to cases where the RSRP of a specific base station does not meet a reference value, i.e., is below the reference value.

To this end, the terminal identifies whether the connected mode discontinuous reception (C-DRX) function is supported, that is, whether C-DRX is configured (S1102), and if the terminal determines that cell DTX/DRX is configured (S1104), the terminal transmits a release request (e.g., deactivation request) for the base station's cell DTX/DRX mode to the base station via RRC signaling (S1105). Thereafter, the terminal connects to and communicates with the base station operating in normal mode after the cell DTX/DRX mode is deactivated (S1107).

If the base station is operating in an energy saving mode based on technologies other than time domain energy saving modes such as cell DTX/DRX, for example, power/spatial/frequency domain energy saving modes, then the release of the base station energy saving mode via RRC signaling by the terminal is not possible. In such cases, the terminal searches for another neighboring base station (S1106) and attempts to connect thereto.

The energy saving effect at the base station can reach up to 93% power reduction according to the technologies specified in the 3GPP TR 38.864 technical report. However, since there is a trade-off between base station energy saving and coverage, it cannot always be applied in commercial environments and is likely to be applied only in a limited manner when the number of terminals connected to the base station is low. Considering this, as described above, energy saving technologies may be applied dynamically depending on whether terminals are using the base station, semi-statically applied only when predefined special environmental conditions are met, or statically configured to operate only during specific times when base station access is very rare (for example, only during off-peak hours from 1 a.m. to 5 a.m., or only on weekends in office environments). Through the application of such energy saving technologies, power consumption at the base station can be reduced, thereby effectively lowering the power consumption cost (e.g., energy costs), which accounts for approximately 20-40% of the total network operating expenditure (OPEX) as mentioned in “GSMA Future Networks: Energy Efficiency: An Overview.”

### Apparatuses to Which the Disclosure Is Applicable

The embodiments described up to now may be implemented through various means. For example, the embodiments may be implemented by hardware, firmware, software, or a combination thereof. Details will be described with reference to the accompanying drawings.

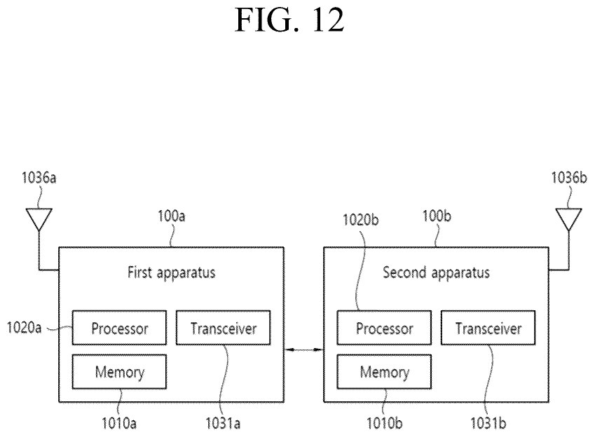

FIG. 12 shows apparatuses according to an embodiment of the disclosure.

Referring to FIG. 12, a wireless communication system may include a first apparatus 100a and a second apparatus 100b.

The first apparatus 100a may include a base station, a network node, a transmission user equipment (UE), a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission UE, a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may perform the foregoing functions, procedures, and/or methods. The processor 1020a may implement one or more protocols. For example, the processor 1020a may perform one or more layers of a radio interface protocol. The memory 1010a may be connected to the processor 1020a and configured to various types of information and/or instructions. The transceiver 1031a may be connected to the processor 1020a, and controlled to transceive a radio signal.

The second apparatus 100b may include at least one processor such as a processor 1020b, at least one memory device such as a memory 1010b, and at least one transceiver such as a transceiver 1031b. The processor 1020b may perform the foregoing functions, procedures, and/or methods. The processor 1020b may implement one or more protocols. For example, the processor 1020b may implement one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

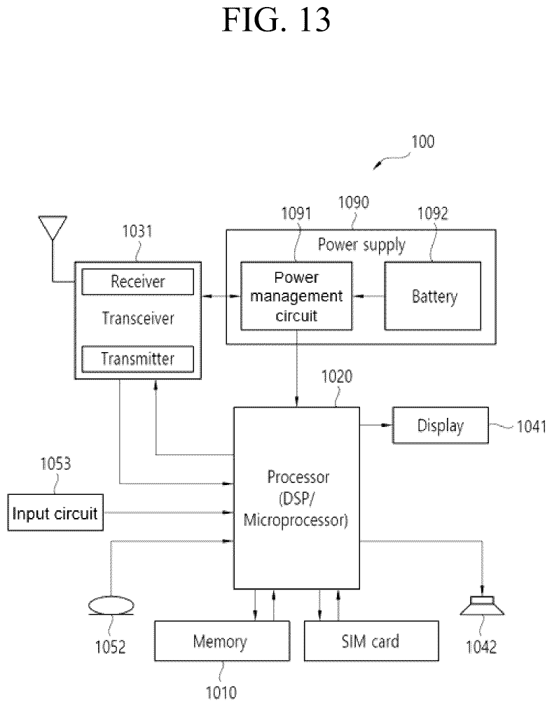

FIG. 13 is a block diagram showing a configuration of a terminal according to an embodiment of the disclosure.

In particular, FIG. 13 illustrates the foregoing apparatus of FIG. 12 in more detail.

The apparatus includes a memory 1010, a processor 1020, a transceiver 1031, a power management circuit 1091, a battery 1092, a display 1041, an input circuit 1053, a loudspeaker 1042, a microphone 1052, a subscriber identification module (SIM) card, and one or more antennas.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management circuit 1091 manages a power for the processor 1020 and/or the transceiver 1031. The battery 1092 supplies power to the power management module 1091. The display 1041 outputs the result processed by the processor 1020. The input circuit 1053 receives an input to be used by the processor 1020. The input unit 1053 may be displayed on the display 1041. The SIM card is an integrated circuit used to safely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. When the embodiment is implemented in software, the techniques described in the present disclosure may be implemented in a module (e.g., process, function, etc.) for performing the function described in the present disclosure. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020 in a way to operate and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

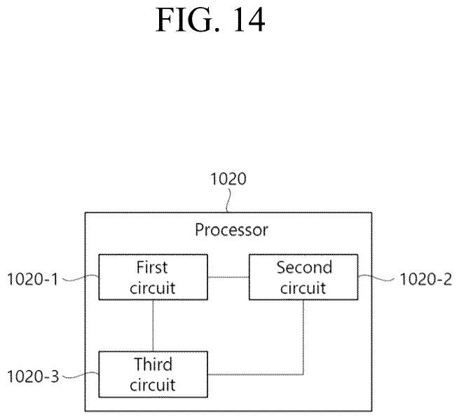

FIG. 14 is a configuration block diagram of a processor in which the disclosure is implemented.

Referring to FIG. 14, a processor 1020 may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP). The processor 1020 may include at least one of a digital signal processor (DSP), a central processing unit (CPU), and a graphics processing unit (GPU).

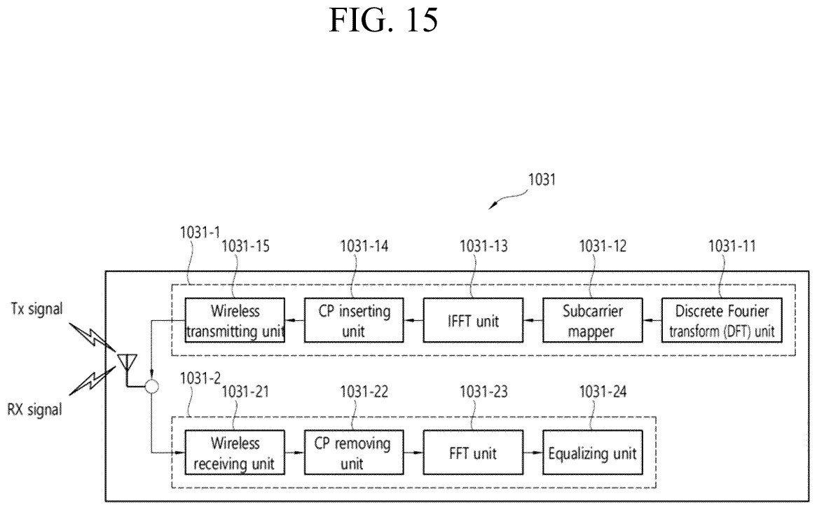

FIG. 15 is a detailed block diagram of a transceiver of a first apparatus shown in FIG. 12 or a transceiving unit of an apparatus shown in FIG. 13.

Referring to FIG. 15, the transceiving unit 1031 includes a transmitter 1031-1 and a receiver 1031-2. The transmitter 1031-1 includes a discrete Fourier transform (DFT) unit 1031-11, a subcarrier mapper 1031-12, an IFFT unit 1031-13, a cyclic prefix (CP) insertion unit 1031-14, and a wireless transmitting unit 1031-15. The transmitter 1031-1 may further include a modulator. Further, the transmitter 1031-1 may for example include a scramble unit (not shown), a modulation mapper (not shown), a layer mapper (not shown), and a layer permutator (not shown), which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some of constituent elements is referred to as a unit in the disclosure. However, the embodiments are not limited thereto. For example, such term “unit” is also referred to as a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21, a CP removing unit 1031-22, an FFT unit 1031-23, and an equalizing unit 1031-24. The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

1. A method of operating a terminal in a wireless communication system, the method comprising:
identifying a base station;
determining whether the identified base station operates in a base station energy saving mode;
transmitting a deactivation request of the base station energy saving mode to the base station; and
transmitting and receiving data with the base station after the base station energy saving mode is deactivated,
wherein the base station energy saving mode is based on cell discontinuous transmission (DTX) and/or cell discontinuous reception (DRX).

2. The method of claim 1, wherein the transmission of the deactivation request of the base station energy saving mode is performed when the terminal is configured with connected mode DRX (C-DRX).

3. The method of claim 1, wherein the deactivation request of the base station energy saving mode is transmitted through radio resource control (RRC) signaling.

4. The method of claim 1, wherein the identification of the base station is based on a reference signal received power (RSRP) of the base station.

5. The method of claim 4, wherein the RSRP is lower than a reference value.

6. A method of operating a first base station in a wireless communication system, the method comprising:
identifying a non-reception of a random access preamble from a terminal;
acquiring a reference signal received power (RSRP) of a second base station after identifying the non-reception of the random access preamble; and
activating a base station energy saving mode when the acquired RSRP of the second base station is greater than or equal to a configured value.

7. The method of claim 6, further comprising:
acquiring a cell identity of the second base station.

8. The method of claim 7, wherein the acquisition of the RSRP of the second base station is based on the cell identity of the second base station.

9. The method of claim 6, wherein the base station energy saving mode is based on cell discontinuous transmission (DTX) and/or cell discontinuous reception (DRX).

10. A communication apparatus in a wireless communication system, comprising:
at least one processor; and
at least one memory configured to store instructions and operably electrically connectable to the at least one processor,
wherein operations performed based on the instructions executed by the at least one processor comprise:
identifying a base station;
determining whether the identified base station is operating in a base station energy saving mode;
transmitting a deactivation request of the base station energy saving mode to the base station; and
transmitting and receiving data with the base station after the base station energy saving mode is deactivated,
wherein the base station energy saving mode is based on cell discontinuous transmission (DTX) and/or cell discontinuous reception (DRX).

11. The communication apparatus of claim 10, wherein the transmission of the deactivation request of the base station energy saving mode is performed when the terminal is configured with connected mode DRX (C-DRX).

12. The communication apparatus of claim 10, wherein the deactivation request of the base station energy saving mode is transmitted through radio resource control (RRC) signaling.

13. The communication apparatus of claim 10, wherein the identification of the base station is based on a reference signal received power (RSRP) of the base station.

14. The communication apparatus of claim 13, wherein the RSRP is lower than a reference value.
